(19) United States
(12) Patent Application Publication
(10) Pub. No.: US 2009/0011674 A1
(43) Pub. Date: Jan. 8, 2009

(54) Method for Producing Planar Metallised Textile Structures, Planar Metallised Textile Structure and Use of the Thus Produced Planar Metallised Textile Structure

(75) Inventors: Antonino Raffaele Addamo, Ludwigshafen (DE); Ralf Norenberg, Ludwigshafen (DE); Bettina Sobotka, Mannheim (DE); Tibor Duris, Ludwigshafen (DE); Rene Lochtman, Mannheim (DE); Norbert Wagner, Mutterstadt (DE); Norbert Schneider, Altrip (DE); Jurgen Pfister, Speyer (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/158,094

(22) PCT Filed: Dec. 18, 2006
(86) PCT No.: PCT/EP2006/069799

§ 371 Date: Jun. 19, 2008

(30) Foreign Application Priority Data
Dec. 22, 2005 (DE) 10 2005 062 028.0

(51) Int. Cl. B05D 5/12; C08K 3/08; D03D 15/00; B32B 15/14

(52) U.S. Cl. 442/228; 524/439; 427/258; 442/376

(57) ABSTRACT

The present invention relates to a process for producing a metalized textile fabric, which comprises a textile fabric being
(A) printed with a printing formulation comprising as a component at least one metal powder (a) selected from pulverulent Zn, Ni, Cu, Sn, Co, Mn, Fe, Mg, Pb, Cr and Bi, mixtures and alloys thereof,
(B) thermally treated in one or more steps,
(C) depositing a further metal on the textile fabric.

The present invention relates to a process for producing a metalized textile fabric, which comprises a textile fabric being
(A) printed with a printing formulation comprising as a component at least one metal powder (a) selected from pulverulent Zn, Ni, Cu, Sn, Co, Mn, Fe, Mg, Pb, Cr and Bi, mixtures and alloys thereof,
(B) thermally treated in one or more steps,
(C) depositing a further metal on the textile fabric.

The present invention further relates to metalized textile fabrics produced by the process of the present invention and to the use of the metalized textile fabric thus produced.

The production of metalized textile fabrics is a field with colossal potential for growth. Metalized textile fabrics can be used for example as heating mantles, also as fashion articles, for example for luminous textiles, or for producing textiles useful in medicine including prophylaxis, for example for monitoring organs and their function. Metalized textile fabrics can further be used to screen off electromagnetic radiation.

However, existing processes for producing them are still very costly and inconvenient and lack flexibility. Special equipment is needed and traditional equipment such as conventional looms for example cannot be used. It is known for example to incorporate metal threads into textile. However, in many cases it is not possible to combine for example copper threads and polyester threads satisfactorily with each other to form wovens, since special looms are needed.

If one attempts to circumvent the above-described disadvantage by incorporating metal threads into a completely made-up textile. Such a procedure generally requires a lot of work by hand and is expensive.

The use of electroconductive polymeric fibers has the additional disadvantage that many electroconductive polymers such as anoxidized polypyrrole for example are air and/or moisture sensitive.

The present invention thus has for its object to provide a process for producing metalized textile fabrics which obviates the disadvantages described above. The present invention further has for its object to provide metalized textile fabrics. The present invention further has for its object to provide uses for novel metalized textile fabrics.

We have found that this object is achieved by the process defined at the beginning.

The process defined at the beginning proceeds from a textile fabric, for example knits or preferably wovens or nonwovens. Textile fabrics for the purposes of the present invention can be flexible or stiff. Preferably, they are textile fabrics which can be bent one or more times by hand for example without it being possible to detect a visual difference between before the bending and after the return from the bent state.

Textile fabrics for the purposes of the present invention can be of natural fibers or synthetic fibers or mixtures of natural fibers and synthetic fibers. Suitable natural fibers include for example wool, flax and preferably cotton. Suitable synthetic fibers include for example, polyamide, polyester, modified polyester, polyester blend fabric, polyamide blend fabric, polyacrylonitrile, triacetate, acetate, polycarbonate, polypropylene, polyvinyl chloride, polyester microfibers, preference here being given to polyester and blends of cotton with synthetic fibers, in particular blends of cotton and polyester.

The process of the present invention is carried out by printing a textile fabric in step (A) with a printing formulation, preferably an aqueous printing formulation, comprising at least one metal powder (a), the metal in question having a more strongly negative standard potential than hydrogen in the electrochemical series of the elements.

Examples of printing formulations are nonjettable printing inks, for example gravure printing inks, offset printing inks, jettable printing inks such as, for example, inks for the Valvoline process and preferably printing pastes, preferably aqueous printing pastes.

Metal powder (a) whose metal has a more strongly negative standard potential than hydrogen in the electrochemical series of the elements will herein also be referred to as metal powder (a) for short.

Metal powder (a) can be selected for example from pulverulent Zn, Ni, Cu, Sn, Co, Mn, Fe, Mg, Pb, Cr and Bi, for example pure or as mixtures or in the form of alloys of the specified metals with each other or with other metals. Examples of suitable alloys are CuZn, CuSn, CuNi, SnPb, SnBi, SnCu, NiP, ZnFe, ZnNi, ZnCo and ZnMn. Preferred metal powders (a) comprise just one metal, particular preference being given to iron powder and copper powder and very particular preference to iron powder.

In one embodiment of the present invention, metal powder (a) has an average particle diameter in the range from 0.01 to 100 μm, preferably in the range from 0.1 to 50 μm and more preferably in the range from 1 to 10 μm (determined by laser diffraction measurement, for example using a Microtrac X100).

In one embodiment, metal powder (a) is characterized by its particle diameter distribution. For example, the d₁₀ value can be in the range from 0.01 to 5 μm, the d₅₀ value in the range from 1 to 10 μm and the d₉₀ value in the range from 3 to 100 μm, subject to the condition: d₁₀<d₅₀<d₉₀. Preferably, no particle has a diameter greater than 100 μm.

Metal powder (a) can be used in passivated form, for example in an at least partially coated form. Examples of suitable coatings include inorganic layers such as oxide of the metal in question, SiO₂ or SiO₂.aq or phosphates for example of the metal in question.

The particles of metal powder (a) can in principle have any desired shape in that for example acicular, lamellar or spherical particles can be used; spherical and lamellar particles are preferred.

It is particularly preferable to use metal powders (a) having spherical particles, preferably predominantly having spherical particles, most preferably so-called carbonyl iron powders having spherical particles.

Metal powder (a) can be printed in one embodiment of step (A) such that the particles of metal powder are so close together that they are already capable of conducting electricity. In another embodiment of step (A), metal powder (a) can be printed such that the particles of metal powder (a) are so far apart from each other that they are not capable of conducting electricity.

The production of metal powders (a) is known per se. For example, common commercial goods can be used or metal powders (a) produced by processes known per se, for example by electrolytic deposition or chemical reduction from solutions of salts of the metals in question or by reduction of an oxidic powder for example by means of hydrogen, by spraying or jetting a molten metal, in particular into cooling media, for example gases or water.

Particular preference is given to using such metal powder (a) as was produced by thermal decomposition of iron pentacarbonyl, herein also referred to as carbonyl iron powder.

The production of carbonyl iron powder by thermal decomposition of, in particular, iron pentacarbonyl Fe(CO)₅ is described for example in Ullmann's Encyclopedia of Industrial Chemistry, 5^{th} Edition, Volume A14, page 599. The decomposition of iron pentacarbonyl can be effected for example at atmospheric pressure and for example at elevated temperatures, for example in the range from 200 to 300° C., for example in a heatable decomposer comprising a tube of heat-resistant material such as quartz glass or V2A steel in a preferably vertical position, the tube being surrounded by heating means, for example consisting of heating tapes, heating wires or a heating mantle through which a heating medium flows.

The average particle diameter of carbonyl iron powder can be controlled within wide limits via the process parameters and reaction management in relation to the decomposition stage, and is in terms of the number average in general in the range from 0.01 to 100 μm, preferably in the range from 0.1 to 50 μm and more preferably in the range from 1 to 8 μm.

In one embodiment of the present invention, step (A) utilizes a printing formulation comprising
(a) at least one metal powder, selected from pulverulent Zn, Ni, Cu, Sn, Co, Mn, Fe, Mg, Pb, Cr and Bi, mixtures and alloys thereof, preferably carbonyl iron powder,
(b) at least one binder,
(c) at least one emulsifier, which may be anionic, cationic or preferably nonionic,
(d) if appropriate at least one rheology modifier.

Printing formulations in accordance with the present invention may comprise at least one binder (b), preferably at least one aqueous dispersion of at least one filming polymer, for example polyacrylate, polybutadiene, copolymers of at least one vinylaromatic with at least one conjugated diene and if appropriate further comonomers, for example styrene-butadiene binders. Further suitable binders (b) are selected from polyurethane, preferably anionic polyurethane, or ethylene-(meth)acrylate acid copolymer.

Useful binder (b) polyacrylates for the purposes of the present invention are obtainable for example by copolymerization of at least one C₁-C₁₀-alkyl (meth)acrylate, for example methyl acrylate, ethyl acrylate, n-butyl acrylate, n-butyl methacrylate, 2-ethylhexyl acrylate, with at least one further comonomer, for example with a further C₁-C₁₀-alkyl (meth)acrylate, (meth)acrylic acid, (meth)acrylamide, N-methylol (meth)acrylamide, glycidyl (meth)acrylate or a vinylaromatic compound such as styrene for example.

Useful binder (b) polyurethanes for the purposes of the present invention, which are preferably anionic, are obtainable for example by reaction of one or more aromatic or preferably aliphatic or cycloaliphatic diisocyanate with one or more polyesterdiols and preferably one or more hydroxy carboxylic acids, for example hydroxyacetic acid, or preferably dihydroxy carboxylic acids, for example 1,1-dimethylolpropionic acid, 1,1-dimethylolbutyric acid or 1,1-dimethylolethanoic acid.

Particularly useful binder (b) ethylene-(meth)acrylic acid copolymers are obtainable for example by copolymerization of ethylene, (meth)acrylic acid and if appropriate at least one further comonomer such as for example C₁-C₁₀-alkyl (meth)acrylate, maleic anhydride, isobutene or vinyl acetate, preferably by copolymerization at temperatures in the range from 190 to 350° C. and pressures in the range from 1500 to 3500 bar and preferably in the range from 2000 to 2500 bar.

Particularly useful binder (b) ethylene-(meth)acrylic copolymers may for example comprise up to 90% by weight of interpolymerized ethylene and have a melt viscosity ν in the range from 60 mm²/s to 10 000 mm²/s, preferably in the range from 100 mm²/s to 5000 mm²/s, measured at 120° C.

Particularly useful binder (b) ethylene-(meth)acrylic acid copolymers may for example comprise up to 90% by weight of interpolymerized ethylene and have a melt flow rate (MFR) in the range from 1 to 50 g/10 min, preferably in the range from 5 to 20 g/10 min and more preferably in the range from 7 to 15 g/10 min, measured at 160° C. under a load to 325 g in accordance with EN ISO 1133.

Particularly useful binder (b) copolymers of at least one vinylaromatic with at least one conjugated diene and if appropriate further comonomers, for example styrene-butadiene binders, comprise at least one ethylenically unsaturated carboxylic acid or dicarboxylic acid or suitable derivative, for example the corresponding anhydride, in interpolymerized form. Particularly suitable vinylaromatics are para-methylstyrene, α-methylstyrene and especially styrene. Particularly suitable conjugated dienes are isoprene, chloroprene and in particular 1,3-butadiene. Particularly suitable ethylenically unsaturated carboxylic acids or dicarboxylic acids or suitable derivatives thereof are (meth)acrylic acid, maleic acid, itaconic acid, maleic anhydride or itaconic anhydride, to name just some examples.

In one embodiment of the present invention, particularly suitable binder (b) copolymers of at least one vinylaromatic with at least one conjugated diene and if appropriate further comonomers comprise in interpolymerized form:

19.9% to 80% by weight of vinylaromatic,
19.9% to 80% by weight of conjugated diene,
0.1% to 10% by weight of ethylenically unsaturated carboxylic acid or dicarboxylic acid or a suitable derivative, for example the corresponding anhydride.

In one embodiment of the present invention, binder (b) has a dynamic viscosity at 23° C. in the range from 10 to 100 dPa·s and preferably in the range from 20 to 30 dPa·s, determined for example by rotary viscometry, for example using a Haake viscometer.

Emulsifier (c) may be an anionic, cationic or preferably nonionic surface-active substance.

Examples of suitable cationic emulsifiers (c) are for example C₆-C₁₈-alkyl-, -aralkyl- or heterocyclyl-containing primary, secondary, tertiary or quaternary ammonium salts, alkanolammonium salts, pyridinium salts, imidazolium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)-ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the Gemini surfactant N,N′-(lauryldimethyl)ethylenediamine dibromide.

Examples of suitable anionic emulsifiers (c) are alkali metal and ammonium salts of alkyl sulfates (alkyl radical: C₈ to C₁₂), of acid sulfuric esters of ethoxylated alkanols (degree of ethoxylation: 4 to 30, alkyl radical: C₁₂-C₁₈) and of ethoxylated alkylphenols (degree of ethoxylation: 3 to 50, alkyl radical: C₄-C₁₂), of alkylsulfonic acids (alkyl radical: C₁₂-C₁₈), of alkyarylsulfonic acids (alkyl radical: C₉-C₁₈) and of sulfosuccinates such as for example sulfosuccinic mono- or diesters. Preference is given to aryl- or alkyl-substituted polyglycol ethers and also to substances described in U.S. Pat. No. 4,218,218, and homologs with y (from the formulae of U.S. Pat. No. 4,218,218) in the range from 10 to 37.

Particular preference is given to nonionic emulsifiers (c) such as for example singly or preferably multiply alkoxylated C₁₀-C₃₀ alkanols, preferably with three to one hundred mol of C₂-C₄-alkylene oxide, in particular ethoxylated oxo process or fatty alcohols.

Examples of particularly suitable multiply alkoxylated fatty alcohols and oxo process alcohols are
n-C₁₈H₃₇O—(CH₂CH₂O)₈₀—H,
n-C₁₈H₃₇O—(CH₂CH₂O)₇₀—H,
n-C₁₈H₃₇O—(CH₂CH₂O)₆₀—H,
n-C₁₈H₃₇O—(CH₂CH₂O)₅₀—H,
n-C₁₈H₃₇O—(CH₂CH₂O)₂₅—H,
n-C₁₈H₃₇O—(CH₂CH₂O)₁₂—H,
n-C₁₆H₃₃O—(CH₂CH₂O)₈₀—H,
n-C₁₆H₃₃O—(CH₂CH₂O)₇₀—H,
n-C₁₆H₃₃O—(CH₂CH₂O)₆₀—H,
n-C₁₆H₃₃O—(CH₂CH₂O)₅₀—H,
n-C₁₆H₃₃O—(CH₂CH₂O)₂₅—H,
n-C₁₆H₃₃O—(CH₂CH₂O)₁₂—H,
n-C₁₂H₂₅O—(CH₂CH₂O)₁₁—H,
n-C₁₂H₂₅O—(CH₂CH₂O)₁₈—H,
n-C₁₂H₂₅O—(CH₂CH₂O)₂₅—H,
n-C₁₂H₂₅O—(CH₂CH₂O)₅₀—H,
n-C₁₂H₂₅O—(CH₂CH₂O)₈₀—H,
n-C₃₀H₆₁O—(CH₂CH₂O)₈—H,
n-C₁₀H₂₁O—(CH₂CH₂O)₉—H,
n-C₁₀H₂₁O—(CH₂CH₂O)₇—H,
n-C₁₀H₂₁O—(CH₂CH₂O)₅—H,
n-C₁₀H₂₁O—(CH₂CH₂O)₃—H,
   and mixtures of the aforementioned emulsifiers, for example mixtures of n-C₁₈H₃₇O—(CH₂CH₂O)₅₀—H and n-C₁₆H₃₃O—(CH₂CH₂O)₅₀—H,
   the indices each being number averages.

In one embodiment of the present invention, printing formulations used in step (A) can comprise at least one rheology modifier (d) selected from thickeners (d1) and viscosity reducers (d2).

Suitable thickeners (d1) are for example natural thickeners or preferably synthetic thickeners. Natural thickeners are such thickeners as are natural products or are obtainable from natural products by processing such as purifying operations for example, in particular extraction. Examples of inorganic natural thickeners are sheet silicates such as bentonite for example. Examples of organic natural thickeners are preferably proteins such as for example casein or preferably polysaccharides. Particularly preferred natural thickeners are selected from agar agar, carrageenan, gum arabic, alginates such as for example sodium alginate, calcium alginate, ammonium alginate, calcium alginate and propylene glycol alginate, pectins, polyoses, carob bean flour (carubin) and dextrins.

Preference is given to using synthetic thickeners selected from generally liquid solutions of synthetic polymers, in particular acrylates, in for example white oil or as aqueous solutions, and from synthetic polymers in dried form, for example spray-dried powders. Synthetic polymers used as thickeners (d1) comprise acid groups, which are neutralized with ammonia completely or to a certain percentage. In the course of the fixing operation, ammonia is released, reducing the pH and starting the actual the fixing process. The pH reduction necessary for fixing may alternatively be effected by adding nonvolatile acids such as for example citric acid, succinic acid, glutaric acid or malic acid.

Very particularly preferred synthetic thickeners are selected from copolymers of 85% to 95% by weight of acrylic acid, 4% to 14% by weight of acrylamide and 0.01 to not more than 1% by weight of the (meth)acrylamide derivative of the formula I

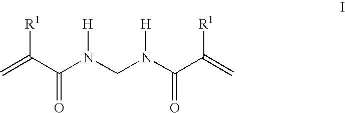

having molecular weights M, in the range from 100 000 to 2 000 000 g/mol, in each of which the R¹ radicals may be the same or different and may represent methyl or hydrogen.

Further suitable thickeners (d1) are selected from reaction products of aliphatic diisocyanates such as for example trimethylene diisocyanate, tetramethylene diisocyanate, hexamethylene diisocyanate or 1,12-dodecane diisocyanate with preferably 2 equivalents of multiply alkoxylated fatty alcohol or oxo process alcohol, for example 10 to 150-tuply ethoxylated C₁₀-C₃₀ fatty alcohol or C₁₁-C₃₁ oxo process alcohol.

Suitable viscosity reducers (d2) are for example organic solvents such as dimethyl sulfoxide (DMSO), N-methylpyrrolidone (NMP), N-ethylpyrrolidone (NEP), ethylene glycol, diethylene glycol, butylglycol, dibutylglycol and for example alkoxylated n-C₄-C₈-alkanol free of residual alcohol, preferably singly to 10-tuply and more preferably 3- to 6-tuply ethoxylated n-C₄-C₈-alkanol free of residual alcohol. Residual alcohol refers to the respectively nonalkoxylated n-C₄-C₈-alkanol.

In one embodiment of the present invention, the printing formulation used in step (A) comprises

from 10% to 90% by weight, preferably from 50% to 85% by weight and more
preferably from 60% to 80% by weight of metal powder (a),
from 1% to 20% by weight and preferably from 2% to 15% by weight of binder (b),
from 0.1% to 4% by weight and preferably up to 2% by weight of emulsifier (c),
from 0% to 5% by weight and preferably from 0.2% to 1% by weight of rheology modifier (d),
weight % ages each being based on the entire printing formulation used in step (A) and relating in the case of binder (b) to the solids content of the respective binder (b).

One embodiment of the present invention comprises printing in step (A) of the process of the present invention with a printing formulation which, in addition to metal powder (a) and if appropriate binder (b), emulsifier (c) and if appropriate rheology modifier (d), comprises at least one auxiliary (e). Examples of suitable auxiliaries (e) are hand improvers, defoamers, wetting agents, leveling agents, urea, actives such as for example biocides or flame retardants:

Suitable defoamers are for example siliconic defoamers such as for example those of the formula HO—(CH₂)₃—Si(CH₃)[OSi(CH₃)₃]₂ and HO—(CH₂)₃—Si(CH₃)[OSi(CH₃)₃][OSi(CH₃)₂OSi(CH₃)₃], nonalkoxylated or alkoxylated with up to 20 equivalents of alkylene oxide and especially ethylene oxide. Silicone-free defoamers are also suitable, examples being multiply alkoxylated alcohols, for example fatty alcohol alkoxylates, preferably 2 to 50-tuply ethoxylated preferably unbranched C₁₀-C₂₀ alkanols, unbranched C₁₀-C₂₀ alkanols and 2-ethylhexan-1-ol. Further suitable defoamers are fatty acid C₈-C₂₀-alkyl esters, preferably C₁₀-C₂₀-alkyl stearates, in each of which C₈-C₂₀-alkyl and preferably C₁₀-C₂₀-alkyl may be branched or unbranched.

Suitable wetting agents are for example nonionic, anionic or cationic surfactants, in particular ethoxylation and/or propoxylation products of fatty alcohols or propylene oxide-ethylene oxide block copolymers, ethoxylated or propoxylated fatty or oxo process alcohols, also ethoxylates of oleic acid or alkylphenols, alkylphenol ether sulfates, alkylpolyglycosides, alkyl phosphonates, alkylphenyl phosphonates, alkyl phosphates or alkylphenyl phosphates.

Suitable leveling agents are for example block copolymers of ethylene oxide and propylene oxide having molecular weights Mₙ in the range from 500 to 5000 g/mol and preferably in the range from 800 to 2000 g/mol. Very particular preference is given to block copolymers of propylene oxide-ethylene oxide for example of the formula EO₈PO₇EO₈, where EO represents ethylene oxide and PO represents propylene oxide.

Suitable biocides are for example commercially obtainable as Proxel brands. Examples which may be mentioned are: 1,2-benzisothiazolin-3-one (BIT) (commercially obtainable as Proxel® brands from Avecia Lim.) and its alkali metal salts; other suitable biocides are 2-methyl-2H-isothiazol-3-one (MIT) and 5-chloro-2-methyl-2H-isothiazol-3-one (CIT).

In one embodiment of the present invention, the printing formulation used in step (A) comprises up to 30% by weight of auxiliary (e), based on the sum total of metal powder (a), binder (b), emulsifier (c) and if appropriate rheology modifier (d).

In one embodiment of the present invention, the printing in step (A) with printing formulation comprising at least one metal powder (a) is uniform. In another embodiment, a pattern of metal powder (a) is printed onto the textile fabric by printing some areas of textile with printing formulation comprising metal powder (a) and not other areas. Preference is given to printing patterns wherein metal powders (a) are arranged on textile in the form of straight or preferably bent stripy patterns or line patterns, wherein the lines mentioned may have for example a width and thickness each in the range from 0.1 μm to 5 mm and the stripes mentioned may have for example a width in the range from 5.1 mm to for example 10 cm or if appropriate more and a thickness in the range from 0.1 μm to 5 mm.

In one specific embodiment of the present invention, stripy patterns or line patterns of metal powder (a) are printed wherein the stripes or lines neither touch nor intersect.

In another specific embodiment of the present invention, stripy patterns or line patterns of metal powder (a) are printed wherein the stripes or lines cross, for example if the intention is to manufacture printed circuits.

In one embodiment of the present invention, printing ink step (A) is effected by various processes which are known per se. One embodiment of the present invention utilizes a stencil through which the printing formulation comprising metal powder (a) is pressed using a squeegee. This process is a screen printing process. Further suitable printing processes are gravure printing processes and flexographic printing processes. A further suitable printing process is selected from valve-jet processes. Valve-jet processes utilize printing formulation comprising preferably no thickener (d1).

The process of the present invention is carried out by treating a printed textile fabric in step (B) thermally, in one or more steps. If it is desired to carry out a plurality of steps for thermal treatment, a plurality of steps can be carried out at the same temperature or preferably at different temperatures.

Treatment temperatures in step (B) or each individual step (B), hereinafter also referred to as step (B1), (B2), (B3), etc., may range for example from 50 to 200° C.

Treatment duration in step (B) or each individual step (B) may range for example from 10 seconds to 15 minutes and preferably from 30 seconds to 10 minutes.

Particular preference is given to treating in a first step (B1) at temperatures in the range of for example 50 to 110° C. for a period of 30 seconds to 3 minutes and in a second step (B2), subsequently, at temperatures in the range from 130° C. to 200° C. for a period of 30 seconds to 15 minutes.

Step (B) or each individual step (B) may be carried out in equipment known per se, for example in atmospheric drying cabinets, tenters or vacuum drying cabinets.

The process of the present invention is carried out by depositing a further metal on the textile fabric in step (C). “Textile fabric” here refers to the textile fabric previously printed in step (A) and thermally treated in step (B).

A plurality of further metals may be deposited in step (C), but it is preferable to deposit just one further metal.

One embodiment of the present invention utilizes carbonyl iron powder as metal powder (a) and silver, gold and in particular copper as further metal.

In one embodiment of the present invention, hereinafter also referred to as step (C1), no external source of voltage is used in step (C1) and the further metal in step (C1) has a more strongly positive standard potential in the electrochemical series of the elements, in alkaline or preferably in acidic solution, than the metal underlying metal powder (a) and than hydrogen.

One possible procedure is for textile fabric printed in step (A) and thermally treated in step (B) to be treated with a basic, neutral or preferably acidic preferably aqueous solution of salt of further metal and if appropriate one or more reducing agents, for example by placing the fabric into the solution in question.

One embodiment of the present invention comprises treating in step (C1) in the range from 0.5 minutes to 12 hours and preferably up to 30 minutes.

One embodiment of the present invention comprises treating in step (C1) with a basic, neutral or preferably acidic solution of salt of further metal, the solution having a temperature in the range from 0 to 100° C. and preferably in the range from 10 to 80° C.

One or more reducing agents may be additionally used in step (C1). When, for example, copper is chosen as further metal, possible reducing agents added include for example aldehydes, in particular reducing sugars or formaldehyde as reducing agent. When, for example, nickel is chosen as further metal, examples of reducing agents which can be added include alkali metal hypophosphite, in particular NaH₂PO₂.2H₂O, or boranates, in particular NaBH₄.

In another embodiment, hereinafter also referred to as step (C2), of the present invention, an external source of voltage is used in step (C2) and the further metal in step (C2) can have a more strongly or more weakly positive standard potential in the electrochemical series of the elements in acidic or alkaline solution than the metal underlying metal powder (a). Preferably, carbonyl iron powder may be chosen for this as metal powder (a) and nickel, zinc or in particular copper as further metal. In the event that the further metal in step (C2) has a more strongly positive standard potential in the electrochemical series of the elements than hydrogen and than metal underlying metal powder (a) it is observed that additionally further metal is deposited analogously to step (C1).

Step (C2) may be carried out for example by applying a current having a strength in the range from 10 to 100 A and preferably in the range from 12 to 50 A.

Step (C2) may be carried out for example by using an external source of voltage for a period in the range from 1 to 60 minutes for example.

In one embodiment of the present invention, step (C1) and step (C2) are combined by initially operating without and then with an external source of voltage and the further metal in step (C) having a more strongly positive standard potential in the electrochemical series of the elements than metal underlying metal powder (a).

One embodiment of the present invention comprises adding one or more auxiliaries to the solution of further metal. Examples of useful auxiliaries include buffers, surfactants, polymers, in particular particulate polymers whose particle diameter is in the range from 10 nm to 10 μm, defoamers, one or more organic solvents, one or more complexing agents.

Acetic acid/acetate buffers are particularly useful buffers.

Particularly suitable surfactants are selected from cationic, anionic and in particular nonionic surfactants.

As cationic surfactants there may be mentioned for example: Examples of suitable cationic emulsifiers (c) are for example C₆-C₁₈-alkyl-, -aralkyl- or heterocyclyl-containing primary, secondary, tertiary or quaternary ammonium salts, alkanolammonium salts, pyridinium salts, imidazolium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)ethylparaffinic esters, N-cetyl-pyridinium chloride, N-laurylpyridinium sulfate and also N-cetyl-N,N,N-trimethyl-ammonium bromide, N-dodecyl-N,N,N-trimethylammonium bromide, N,N-distearyl-N,N-dimethylammonium chloride and also the Gemini surfactant N,N′-(lauryldimethyl)-ethylenediamine dibromide.

Examples of suitable anionic surfactants are alkali metal and ammonium salts of alkyl sulfates (alkyl radical: C₈ to C₁₂), of acid sulfuric esters of ethoxylated alkanols (degree of ethoxylation: 4 to 30, alkyl radical: C₁₂-C₁₈) and of ethoxylated alkylphenols (degree of ethoxylation: 3 to 50, alkyl radical: C₄-C₁₂), of alkylsulfonic acids (alkyl radical: C₁₂-C₁₈), of alkyarylsulfonic acids (alkyl radical: C₉-C₁₈) and of sulfosuccinates such as for example sulfosuccinic mono- or diesters. Preference is given to aryl- or alkyl-substituted polyglycol ethers and also to substances described in U.S. Pat. No. 4,218,218, and homologs with y (from the formulae of U.S. Pat. No. 4,218,218) in the range from 10 to 37.

Particular preference is given to nonionic surfactants such as for example singly or preferably multiply alkoxylated C₁₀-C₃₀ alkanols, preferably with three to one hundred mol of C₂-C₄-alkylene oxide, in particular ethoxylated oxo process or fatty alcohols.

Suitable defoamers are for example siliconic defoamers such as for example those of the formula HO—(CH₂)-3—Si(CH₃)[OSi(CH₃)₃]₂ and HO—(CH₂)-3—Si(CH₃)[OSi(CH₃)₃][OSi(CH₃)₂OSi(CH₃)₃], nonalkoxylated or alkoxylated with up to 20 equivalents of alkylene oxide and especially ethylene oxide. Silicone-free defoamers are also suitable, examples being multiply alkoxylated alcohols, for example fatty alcohol alkoxylates, preferably 2 to 50-tuply ethoxylated preferably unbranched C₁₀-C₂₀ alkanols, unbranched C₁₀-C₂₀ alkanols and 2-ethylhexan-1-ol. Further suitable defoamers are fatty acid C₈-C₂₀-alkyl esters, preferably C₁₀-C₂₀-alkyl stearates, in each of which C₈-C₂₀-alkyl and preferably C₁₀-C₂₀-alkyl may be branched or unbranched.

Suitable complexing agents are such compounds as form chelates. Preference is given to such complexing agents as are selected from amines, diamines and triamines bearing at least one carboxylic acid group. Suitable examples are nitrilotriacetic acid, ethylenediaminetetraacetic acid and diethylenepentaminepentaacetic acid and also the corresponding alkali metal salts.

One embodiment of the present invention comprises depositing sufficient further metal as to produce a layer thickness in the range from 100 nm to 100 μm and preferably in the range from 1 μm to 10 μm.

Step (C) is carried out by metal powder (a) being in most cases partially or completely replaced by further metal, and the morphology of further deposited metal need not be identical to the morphology of metal powder (a).

On completion of the deposition of further metal a textile fabric metalized in accordance with the present invention is obtained. Textile fabric metalized in accordance with the present invention can be rinsed one or more times with water for example.

To produce for example such textile fabrics as are to be used for producing electrically heatable car seats, electric leads can be secured to the ends in a conventional manner, for example by soldering.

The present invention further provides metalized textile fabrics obtainable by the process described above. Metalized textile fabrics in accordance with the present invention are not just produced in an efficient and specific manner. For instance, the flexibility and electrical conductivity, for example, can be influenced in a specific manner by the identity of the printed pattern of metal powder (a) and by the amount of deposited further metal for example. Metalized textile fabrics in accordance with the present invention are also flexible in use, for example in applications for electroconductive textiles.

In one embodiment of the present invention, metalized textile fabrics in accordance with the present invention which have been printed with a line or stripy pattern have a specific resistance in the range from 1 mΩ/cm² to 1 MΩ/cm² or in the range from 1 μΩ/cm to 1 MΩ/cm, measured at room temperature and along the stripes or the lines in question.

In one embodiment of the present invention, metalized textile fabrics printed with a line or stripy pattern and in accordance with the present invention comprise at least two leads secured in a conventional manner, for example soldered, to the respective ends of lines or stripes.

The present invention further provides for the use of metalized textile fabrics in accordance with the present invention, for example for producing heatable textiles, in particular heatable car seats and heatable carpets, wall coverings and clothing.

The present invention further provides for the use of metalized textile fabrics in accordance with the present invention as or for producing textiles that convert electricity into heat, furthermore, textiles able to screen off natural or artificial electric fields, textile-integrated electronic systems and RFID textiles. RFID textiles are for example textiles capable of identifying a radio frequency, for example by means of a transponder or an RFID tag. Such devices do not require an internal source of electricity.

Examples of textile-integrated electronics are textile-integrated sensors, transistors, chips, light emitting diodes (LEDs), solar modules, solar cells and Peliter elements. Textile-integrated sensors are suitable for example for monitoring the bodily functions of infants or older people. Suitable applications further include high conspicuity clothing such as high conspicuity vests for example.

The present invention accordingly provides processes for producing heatable textiles, for example heatable wall coverings, carpets and curtains, heatable car seats and heatable carpets, also for producing such textiles as convert electricity into heat, also such textiles as are capable of screening off electric fields, textile-integrated electronics and RFID textiles using metalized textile fabrics in accordance with the present invention. Present invention processes for producing heatable textiles, such textiles as convert electricity into heat, also such textiles as are capable of screening off electric fields, and RFID textiles using metalized textile fabrics in accordance with the present invention can be carried out for example by making up metalized textile fabric in accordance with the present invention.

The present invention specifically provides heatable car seats produced using metalized textile fabrics in accordance with the present invention. Heatable car seats in accordance with the present invention require for example little current to produce a pleasant seat temperature, and therefore relieve the car's battery, an advantage in winter in particular. Furthermore, the process of the present invention makes it possible to produce heatable car seats in a flexible design, and this ensures a comfortable distribution of heat, for example due to few hot spots.

The present invention specifically provides wallcoverings, carpets and curtains produced using or consisting of metalized textile fabrics in accordance with the present invention.

The present invention further provides printing formulations, preferably printing pastes, comprising
(a) at least one metal powder, in particular carbonyl iron powder, selected from pulverulent Zn, Ni, Cu, Sn, Co, Mn, Fe, Mg, Pb, Cr and Bi, mixtures and alloys thereof,
(b) at least one binder,
(c) at least one emulsifier,
(d) if appropriate at least one rheology modifier (d).

Metal powder (a), binder (b), emulsifiers (c) and rheology modifiers (d) are described above.

Printing formulations in accordance with the present invention may further comprise one or more above-described auxiliaries (e).

In one embodiment of the present invention, the printing formulation in accordance with the present invention comprises

from 10% to 90% by weight, preferably from 50% to 80% by weight of metal powder (a), in particular carbonyl iron powder,
from 5% to 30% by weight and preferably from 10% to 15% by weight of binder (b),
from 0.1% to 4% by weight and preferably up to 2% by weight of emulsifier (c),
from 0% to 5% by weight and preferably from 0.2% to 1% by weight of rheology modifier (d),
weight % ages each being based on the entire printing formulation used in step (A).

In one embodiment of the present invention, the printing formulation according to the present invention comprises up to 30% by weight of auxiliary (e), based on the sum total of metal powder (a), binder (b), emulsifier (c) and rheology modifier (d).

The present invention further provides a process for producing printing formulations which are in accordance with the present invention by mixing
(a) at least one metal powder, selected from pulverulent Zn, Ni, Cu, Sn, Co, Mn, Fe, Mg, Pb, Cr and Bi, mixtures and alloys thereof, particular preference being given to carbonyl iron powder
(b) at least one binder,
(c) at least one emulsifier,
(d) if appropriate at least one rheology modifier,
   and also if appropriate one or more auxiliaries (e) together in any order.

To produce printing formulations which are in accordance with the present invention, one procedure is for example to stir together water and if appropriate one or more auxiliaries, for example a defoamer, for example a silicone-based defoamer. Thereafter, one or more emulsifiers can be added.

Next, one or more hand improvers can be added, for example one or more silicone emulsions.

Thereafter one or more emulsifiers (c) and/or the metal powder or powders (a) can be added.

Subsequently, one or more binders (b) and finally if appropriate one or more rheology modifiers (d) can be added and the mixture homogenized with continued mixing, for example by stirring. Sufficient stirring times are customarily comparatively short, for example in a range from 5 seconds to 5 minutes and preferably in the range from 20 seconds to 1 minute at stirrer speeds in the range from 1000 to 3000 rpm.

The ready-produced printing formulation in accordance with the present invention may comprise 30% to 70% by weight of white oil when it is to be used as a printing paste. Aqueous synthetic thickeners (d1) preferably comprise up to 25% by weight of synthetic polymer useful as thickener (d1). To use aqueous formulations of thickener (d1), aqueous ammonia is generally added. Similarly, the use of granular, solid formulations of thickener (c) are useable in order that prints may be produced emissionlessly.

The invention is elucidated by working examples.

### I. Production of an Inventive Printing Paste

The following are stirred together:

54 g of water
750 g of carbonyl iron powder, not passivated, d₁₀ 3 μm, d₅₀ 4.5 μm, d₉₀ 9 μm.
125 g of an aqueous dispersion, pH 6.6, solids content 39.3% by weight, of a random emulsion copolymer of 1.9 parts of N-methylolacrylamide, 1.3 parts by weight of acrylic acid, 9.8 parts by weight of styrene, 40 parts by weight of n-butyl acrylate, 47 parts by weight of ethyl acrylate, parts by weight all based on total solids, average particle diameter (weight average) 172 nm, determined by Coulter Counter, T_{g}: −19° C. (binder b.1) dynamic viscosity (23° C.) 70 mPa·s,
20 g of compound of the formula

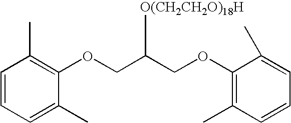

20 g of a 51% by weight solution of a reaction product of hexamethyl diisocyanate with n-C₁₈H₃₇(OCH₂CH₂)₁₅OH in isopropanol/water (volume fractions 2:3)

Stirring was done for 20 minutes at 5000 rpm (Ultra-Thurrax) to obtain a printing paste having a dynamic viscosity of 30 dPa·s at 23° C., measured using a Haake rotary viscometer.

### II. Printing of Textile, Step (A), and Thermal Treatment, Step (B)

The print paste of I. was used to print a polyester nonwoven, basis weight 90 g/cm² using a 120 mesh sieve with a stripy pattern.

This was followed by drying in a drying cabinet at 100° C. for 10 minutes. Thereafter, fixing was carried out in a drying cabinet at a temperature of 150° C. for a period of 5 minutes.

A printed and thermally treated polyester nonwoven was obtained.

III. Depositing a further metal, step (C)
III.1 Depositing copper without external source of voltage

Printed and thermally treated polyester nonwoven of II. was treated for 10 minutes in a bath (room temperature) having the following composition:

### 1.47 kg of CuSO₄-5H₂O

### 382 g of H₂SO₄

5.1 l of distilled water

### 1.1 g of NaCl

5 g of C₁₃/C₁₋₅-alkyl-O-(EO)₁₋₀(PO)₅—CH₃

### (EO: CH₂—CH₂—O, PO: CH₂—CH(CH₃)—O)

The polyester nonwoven was removed, rinsed twice under running water and dried at 90° C. for one hour.

Inventive metalized textile T-1 was obtained.

### III.2 Depositing Further Metal by Electroplating

Printed and thermally treated polyester nonwoven of II. was in each case treated in an electroplating bath having the following composition:

### 1.47 kg of CuSO₄.5H₂O

### 382 g of H₂SO₄

5.1 l of distilled water

### 1.1 g of NaCl

5 g of C₁₃/C₁₅-alkyl-O-(EO)₁₀(PO)₅—CH₃

The polyester nonwoven was removed, rinsed twice under running water and dried at 90° C. for one hour.

### III.2.1 Electroplating for 10 Minutes

Electroplating was carried out in an above-described electroplating bath for 10 minutes using an electrode as cathode and connecting the anode at the contact of the printed polyester nonwoven.

Inventive metalized textile T-2 was obtained.

### III.2.1 Electroplating for 30 Minutes

Electroplating was carried out in an above-described electroplating bath for 30 minutes using an electrode as cathode and connecting the anode at the contact of the printed polyester nonwoven.

Inventive metalized textile T-3 was obtained.

### IV. Test of Heatability

### IV.1 Test of Heatability of T-2

Initially inventive metalized textile T-2 was tested by applying a current of (how much) (or voltage). Current, voltage and resistance behaved as shown in Table 1.

TABLE 1
Test of heatability of T-2

| No. | U [V] | I[A] | T[° C.] |
|---|---|---|---|
| 1 | 1 | — | 23.7 |
| 1 | 3 | 0.05 | 23.8 |
| 1 | 5 | 0.1 | 24 |
| 1 | 7 | 0.2 | 24.4 |
| 1 | 10 | 0.3 | 25.5 |
| 1 | 12 | 0.4 | 27 |

R at contact: 38 Ω

| | | | |
|---|---|---|---|
| 2 | 1 | 0.05 | 24.0 |
| 2 | 3 | 0.1 | 24.3 |
| 2 | 5 | 0.2 | 24.7 |
| 2 | 7 | 0.3 | 25.3 |
| 2 | 10 | 0.4 | 26.8 |
| 2 | 12 | 0.5 | 28.5 |

R at contact: 24 Ω

| | | | |
|---|---|---|---|
| 3 | 1 | — | 24 |
| 3 | 3 | 0.05 | 24.3 |
| 3 | 5 | 0.15 | 24.6 |
| 3 | 7 | 0.2 | 25.1 |
| 3 | 10 | 0.3 | 26.1 |
| 3 | 12 | 0.35 | 27.2 |

R at contact: 35 Ω

### IV.2 Test of Heatability of T-3

Initially inventive metalized textile T-3 was tested by applying a current as shown in Table 2 (or voltage). Current, voltage and resistance behaved as shown in Table 2.

TABLE 2
Test of heatability of T-3

| No. | U[V] | I[A] | T[° C.] |
|---|---|---|---|
| 1 | 1 | 0.15 | 31.2 |
| 1 | 3 | 0.5 | 31.6 |
| 1 | 5 | 0.9 | 34 |
| 1 | 7 | 1.4 | 40 |
| 1 | 10 | 1.7 | 42 |
| 1 | 12 | 2 | 45 |

R at contact: 10 Ω

| | | | |
|---|---|---|---|
| 2 | 1 | 0.25 | 24.6 |
| 2 | 3 | 1.0 | 25.8 |
| 2 | 5 | 1.7 | 30.8 |
| 2 | 7 | 2.5 | 37.6 |
| 2 | 10 | 3.0 | 50 |
| 2 | 12 | 3.0 | 65 |

R at contact: 5 Ω

| | | | |
|---|---|---|---|
| 3 | 1 | 0.15 | 28.4 |
| 3 | 3 | 0.65 | 29.6 |
| 3 | 5 | 1.1 | 31.4 |
| 3 | 7 | 1.6 | 35.4 |
| 3 | 10 | 2.1 | 50 |
| 3 | 12 | 2.4 | 55 |

R at contact: 5.4 Ω

| | | | |
|---|---|---|---|
| 4 | 1 | 0.15 | 30.8 |
| 4 | 3 | 0.5 | 30.9 |
| 4 | 5 | 0.9 | 32.9 |
| 4 | 7 | 1.5 | 34.3 |
| 4 | 10 | 1.9 | 40.0 |
| 4 | 12 | 2.2 | 50.0 |

R at contact: 5.6 Ω

1: A process for producing a metalized textile fabric, comprising:
(A) printing onto a textile fabric with an aqueous printing formulation that comprises:
(a) at least one metal powder selected from the group consisting of pulverulent Zn, Ni, Cu, Sn, Co, Mn, Fe, Mg, Pb, Cr and Bi, mixtures and alloys thereof,
(b) at least one binder,
(c) at least one emulsifier,
(B) thermal-treating the printed textile fabric in one or more steps,
(C) depositing a further metal on the textile fabric.

2: The process according to claim 1 wherein textile fabrics are selected from the group consisting of cotton and synthetic fibers and blends of cotton and synthetic fibers.

3: The process according to claim 1 wherein textile fabrics are selected from the group consisting of woven textile fabrics and nonwoven textile fabrics.

4: The process according to claim 1 wherein a pattern of metal powder (a) is printed onto the textile fabric in (A), so that the metalized textile fabric printed, thermally treated, and provided with a further metal partially conducts electric current.

5: The process according to claim 1 wherein metal powder (a) is obtained by thermal decomposition of iron pentacarbonyl.

6: The process according to claim 1 wherein no external source of voltage is used in (C) and the further metal in (C) has a more strongly positive standard potential than the metal underlying metal powder (a).

7: The process according to claim 1 wherein an external source of voltage is used in (C) and the further metal in (C) has a more strongly or more weakly positive standard potential than the metal underlying metal powder (a).

8: The process according to claim 1 wherein a pattern is printed onto the textile fabric in (A).

9: The process according to claim 1 wherein emulsifier (c) is a nonionic emulsifier.

10: A metalized textile fabric obtained by a process according to claim 1.

11: A process for producing a heatable textile comprising incorporating the metalized textile fabric according to claim 10 into a textile.

12: A heatable textile comprising the metalized textile fabric according to claim 10.

13: A heatable car seat comprising the heatable textile according to claim 12.

14: An aqueous printing formulation comprising
(a) at least one metal powder selected from the group consisting of pulverulent Zn, Ni, Cu, Sn, Co, Mn, Fe, Mg, Pb, Cr and Bi, mixtures and alloys thereof,
(b) at least one binder,
(c) at least one emulsifier.

15: The printing formulation according to claim 14 wherein binder (b) is an aqueous dispersion of at least one film-forming polymer selected from the group consisting of polyacrylate, polybutadiene, polyurethane, ethylene (meth)acrylic acid copolymer, and a copolymer of at least one vinylaromatic with at least one conjugated diene and if appropriate further comonomers.

16: The printing formulation according to claim 14, wherein the formulation is a printing paste.

17: A process for producing a printing formulation according to claim 14, which comprises mixing
(a) at least one metal powder selected from the group consisting of pulverulent Zn, Ni, Cu, Sn, Co, Mn, Fe, Mg, Pb, Cr and Bi, mixtures and alloys thereof,
(b) at least one binder,
(c) at least one emulsifier, together.

18: A process for producing a textile that converts electricity into heat comprising incorporating the metalized textile fabric according to claim 10 into a textile.

19: A process for producing a textile able to screen off an electric field comprising incorporating the metalized textile fabric according to claim 10 into a textile.

20: A process for producing a textile-integrated electronic system comprising incorporating the metalized textile fabric according to claim 10 into a system.

21: A process for producing a RFID textile comprising incorporating the metalized textile fabric according to claim 10 into a textile.

22: A textile that converts electricity into heat comprising the metalized textile fabric according to claim 10.

23: A textile able to screen off an electric field comprising the metalized textile fabric according to claim 10.

24: A textile-integrated electronic system comprising the metalized textile fabric according to claim 10.

25: A RFID textile comprising the metalized textile fabric according to claim 10.

26: The process according to claim 1, wherein the formulation of (A) further comprises at least one rheology modifier.

27: The aqueous printing formulation of claim 14 further comprising at least one rheology modifier.

28: The process according to claim 17 further comprising adding at least one rheology modifier.
